(19) United States
(12) Patent Application Publication
(10) Pub. No.: US 2026/0130570 A1
(43) Pub. Date: May 14, 2026

(54) RAKE AND BIN DEVICE

(71) Applicant: Canaan Peasley, Huntington Beach, CA (US)

(72) Inventor: Canaan Peasley, Huntington Beach, CA (US)

(21) Appl. No.: 18/946,057

(22) Filed: Nov. 13, 2024

(51) Int. Cl. A47L 13/50

(52) U.S. Cl. CPC A47L 13/50

(57) ABSTRACT

A rake and bin device includes a bin which has a shell structured to have a pair of lobes such that the bin has the ornamental appearance of a fish with an open mouth. A bin handle is attached to shell to be gripped by a user. A pair of fins is coupled to the shell and a tail is coupled to the shell to enhance the ornamental appearance of the bin with respect to the fish. A rake is provided to rake toys and other children's objects into the bin for collection without damaging the toys and other children's objects. A plurality of wings each extends laterally away from the rake to enhance the ornamental appearance of the rake. A rake handle extends upwardly from the a respective one of the plurality of wings for gripping to rake the toys and other children's objects into the bin for collection.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to rake and bin devices and more particularly pertains to a new rake and bin device for collection toys and other children's objects from a play area. The device includes a bin structured to have the ornamental appearance of a fish with an open mouth. The device includes a rake that that has a plurality of wings extending laterally from the rake to enhance the ornamental appearance of the rake. The rake has a rake handle which has a telescopically adjustable length to accommodate preferences of a user. The rake has a plurality of tines that are comprised of resiliently bendable material to enable to the rake to rake toys and other children's objects into the bin without damaging the toys and other children's objects. In this way the toys and other children's objects can be collected from the play area and transported in the bin to a storage area.

### (2) Description of Related Art Including Information Disclosed under 37 CFR 1.97 and 1.98

The prior art relates to rake and bin devices including a broom and bin device that includes a broom for sweeping and a bin for collection dust and debris that is swept by the broom and a variety of dust pan devices that each at least includes a bin for collecting debris or objects and a handle extending upwardly from the bin and a scoop and bin device that includes a bin for receiving a disposable bag for receiving waste and a scoop that includes a handle and tines for urging waste into the disposable bag in the bin and a toy collection device that includes a bin and a telescopically adjustable handle attached to the bin to enable the bin to scoop toys for collection from a play area. In no instance does the prior art disclose a rake and bin device that includes a bin and a bin handle attached to the bin and a rake which has a telescopically adjustable rake handle for raking toys and other children's objects from a play area into the bin for subsequent deposit into a storage area.

### BRIEF SUMMARY OF THE INVENTION

An embodiment of the disclosure meets the needs presented above by generally comprising bin which has a shell structured to have a pair of lobes such that the bin has the ornamental appearance of a fish with an open mouth. A bin handle is attached to shell to be gripped by a user. A pair of fins is coupled to the shell and a tail is coupled to the shell to enhance the ornamental appearance of the bin with respect to the fish. A rake is provided to rake toys and other children's objects into the bin for collection without damaging the toys and other children's objects. A plurality of wings each extends laterally away from the rake to enhance the ornamental appearance of the rake. A rake handle extends upwardly from the a respective one of the plurality of wings for gripping to rake the toys and other children's objects into the bin for collection.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a rake and bin device according to an embodiment of the disclosure.

FIG. 2 is a front view of a rake of an embodiment of the disclosure.

FIG. 3 is a left side view of a rake of an embodiment of the disclosure.

FIG. 4 is a cross sectional view taken along line 4-4 of FIG. 2 of an embodiment of the disclosure.

FIG. 5 is a front perspective view of a bin of an embodiment of the disclosure.

FIG. 6 is a front view of a bin of an embodiment of the disclosure.

FIG. 7 is a perspective in-use view of an embodiment of the disclosure.

### DETAILED DESCRIPTION OF THE INVENTION

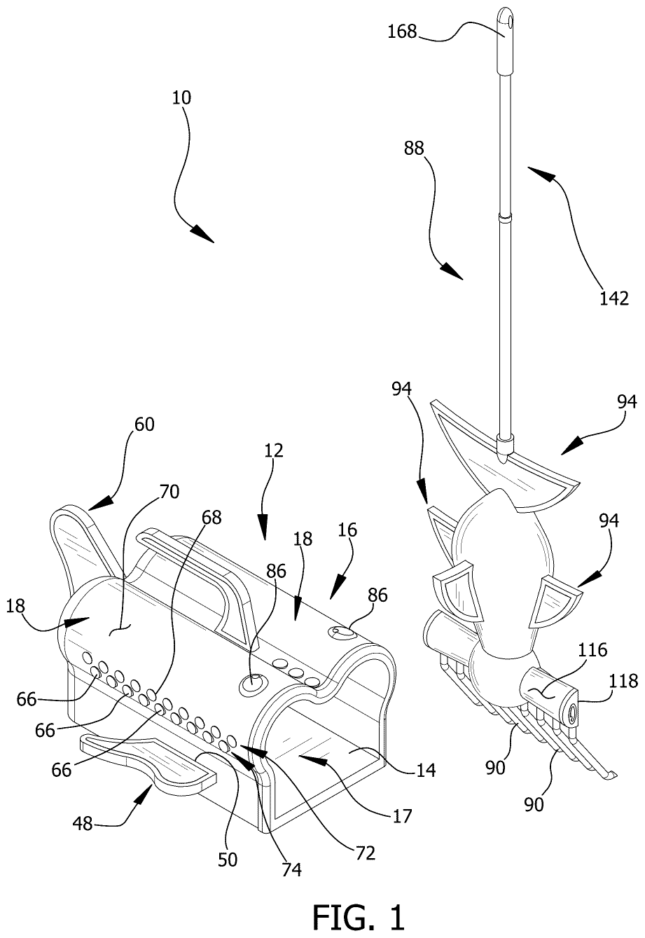

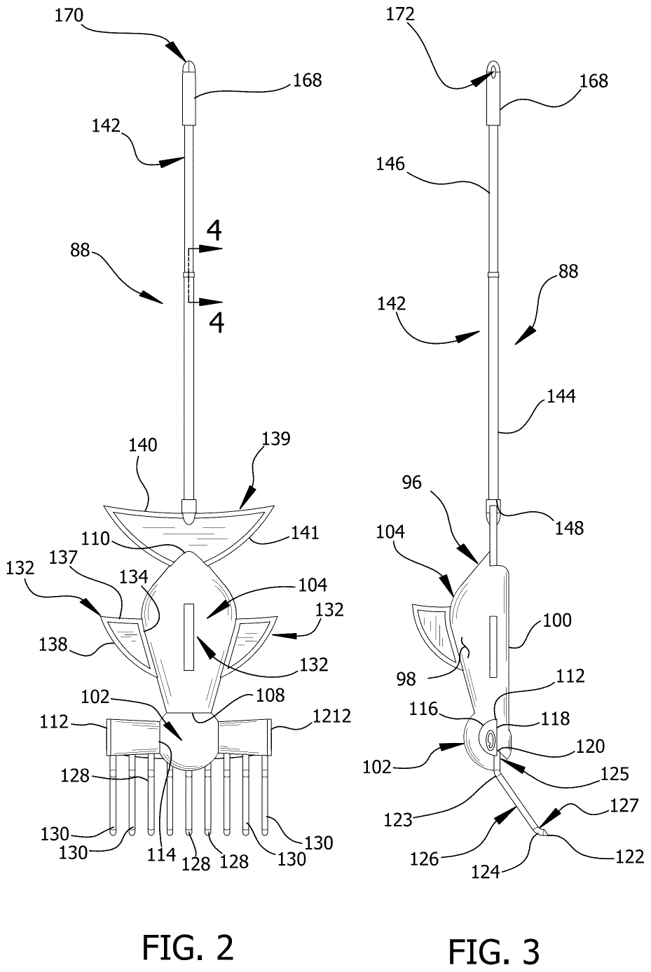

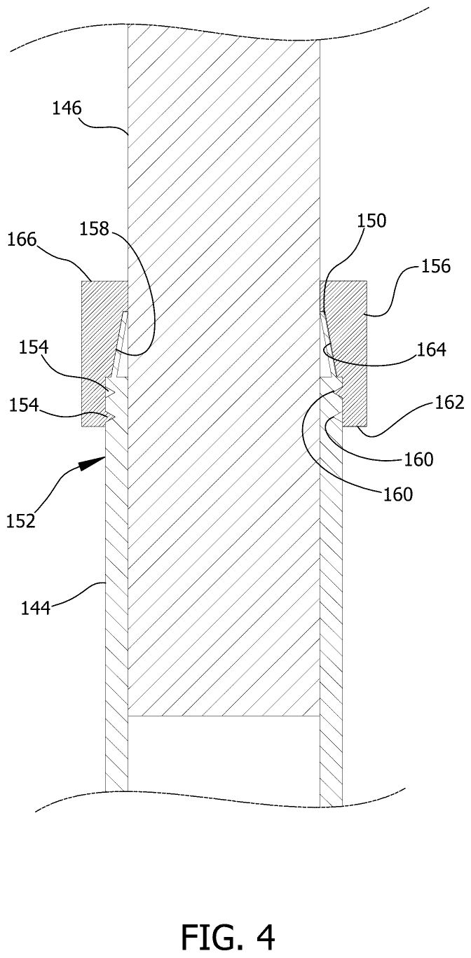

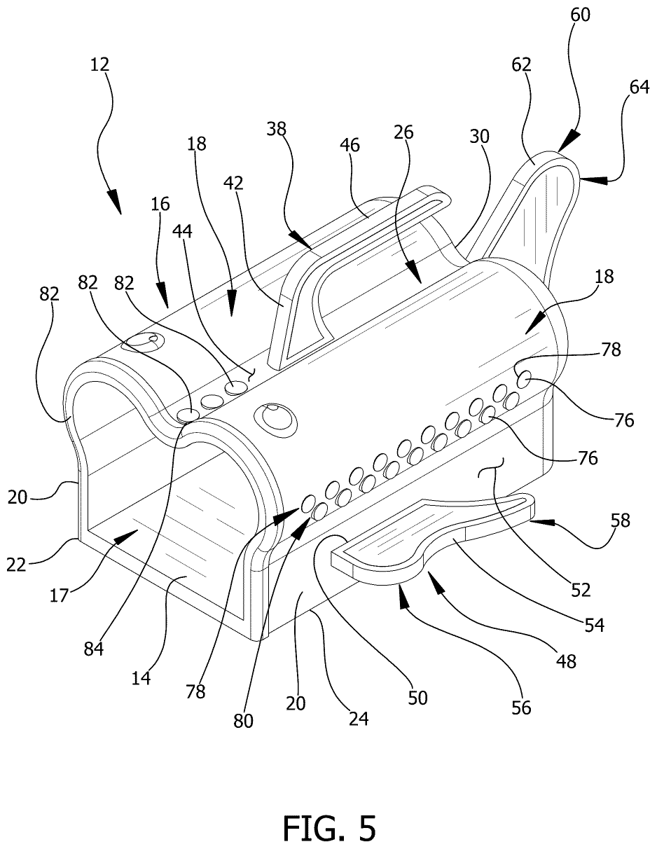

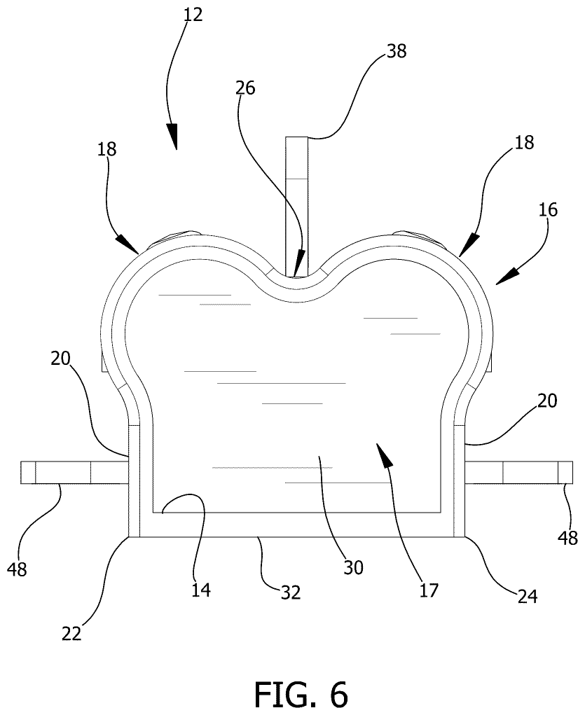

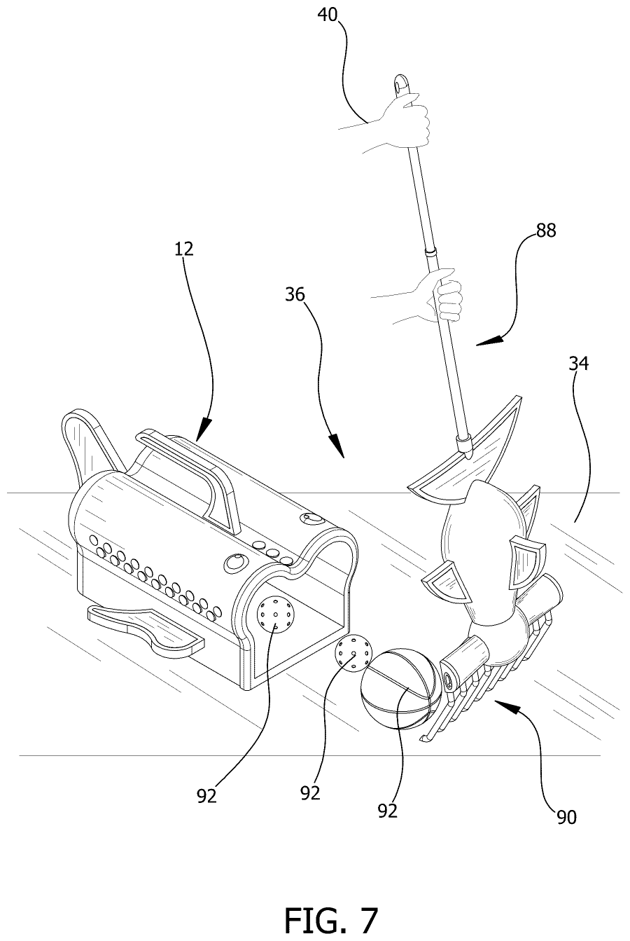

With reference now to the drawings, and in particular to FIGS. 1 through 7 thereof, a new rake and bin device embodying the principles and concepts of an embodiment of the disclosure and generally designated by the reference numeral 10 will be described.

As best illustrated in FIGS. 1 through 7, the rake and bin device 10 generally comprises a bin 12 which has a lower wall 14 and a shell 16 extending upwardly from the lower wall 14 to define a collection space 17 in the bin 12. The shell 16 is structured to have a pair of lobes 18 each being spaced upwardly from the lower wall 14 and being elongated to extend along a full length of the lower wall 14 having the pair of lobes 18 being laterally spaced apart from each other. In this way the bin 12 is structured to have the ornamental appearance of a fish with an open mouth. The shell 16 has a pair of lateral walls 20 each extending upwardly from a respective one of a first lateral edge 22 and a second lateral edge 24 of the lower wall 14 and each of the pair of lateral walls 20 intersects a respective one of the pair of lobes 18. The shell 16 has a medial section 26 which extends between the pair of lobes 18 and the medial section 26 lies on a plane which is oriented parallel to the lower wall 14. The shell 16 has a front end 28 which is open into the collection space 17 and the shell 16 has a rear end 30 which is closed. A bottom surface 32 of the lower wall 14 lies on a plane which is horizontally oriented to rest on a floor 34 of a play area 36. The play area 36 may be a room in a house, a yard or any other location where children play with toys, for example.

A bin handle 38 is attached to and extends upwardly from the shell 16 such that the bin handle 38 can be gripped by a user 40 for positioning the bin 12. The bin handle 38 has a bottom portion 42 which is attached to and extends upwardly from an exterior surface 44 of the medial section 26 of the shell 16 at a point that is spaced from the front end 28 of the shell 16. The bin handle 38 has a top portion 46 which is perpendicular to the bottom portion 42 such that the top portion 46 is spaced from and is oriented parallel with the exterior surface 44 of the medial section 26 thereby enabling the top portion 46 to be gripped.

A pair of fins 48 is each coupled to and extends laterally away from opposite sides of the shell 16 to enhance the ornamental appearance of the bin 12 with respect to the fish. Each of the pair of fins 48 has a coupled edge 50 which is coupled to an exterior surface 52 of a respective one of the pair of lateral walls 20 of the shell 16. Each of the pair of fins 48 is positioned between the lower wall 14 and a respective one of the pair of lobes 18 of the shell 16. Each of the pair of fins 48 has a perimeter edge 54 which is curved to define a front lobe 56 of a respective fin 48 and a rear lobe 58 of the respective fin 48. The front lobe 56 of each of the pair of fins 48 curves laterally away from the exterior surface 52 of the respective lateral wall 20 of the shell 16 and the rear lobe 58 of each of the pair of fins 48 curves toward the rear end 30 of the shell 16. Furthermore, each of the pair of fins 48 is oriented to lie on a plane which is oriented parallel to the lower wall 14 of the bin 12. A tail 60 is coupled to and extends rearwardly from the shell 16 to enhance to the ornamental appearance of the bin 12 with respect to the fish and the tail 60 is positioned on the rear end 30 of the shell 16. Additionally, the tail 60 has a perimeter edge 62 which is curved to define a lobe 64 of the tail 60 which extends rearwardly and upwardly from the rear end 30 of the shell 16.

A plurality of first disks 66 each has a coupled surface 68 which is attached to an exterior surface 70 of a respective one of the pair of lobes 18 of the shell 16. In this way each of the plurality of first disks 66 has the ornamental appearance of scales of the fish. The plurality of first disks 66 includes a first row of first disks 72 evenly spaced apart from each other and distributed along an axis extending between the front end 28 and the rear end 30 of the shell 16. The plurality of first disks 66 includes a second row of first disks 74 evenly spaced apart from each other and distributed along the axis extending between the front end 28 and the rear end 30 of the shell 16. Furthermore, the second row of first disks 74 is positioned beneath the first row of first disks 72 and each of the second row of the first disks 74 is staggered with respect to each of the first row of the first disks 72.

A plurality of second disks 76 each has a coupled surface 77 which is attached to the exterior surface 70 of a respective one of the pair of lobes 18 of the shell 16. In this way each of the plurality of second disks 76 has the ornamental appearance of scales of the fish. The plurality of second disks 76 includes a first row of second disks 78 evenly spaced apart from each other and distributed along the axis extending between the front end 28 and the rear end 30 of the shell 16. Additionally, the plurality of second disks 76 includes a second row of second disks 80 evenly spaced apart from each other and distributed along the axis extending between the front end 28 and the rear end 30 of the shell 16. Furthermore, the second row of second disks 80 is positioned beneath the first row of second disks 78 and each of the second row of the second disks 80 is staggered with respect to each of the first row of the second disks 78.

A plurality of third disks 82 each has a coupled surface 84 which is attached to the exterior surface 44 of the medial section 26 of the shell 16. In this way each of the plurality of third disks 82 has the ornamental appearance of scales of the fish. The third disks 82 are evenly spaced apart from each other and are distributed between the front end 28 of the shell 16 and the bottom portion 42 of the bin handle 38. A pair of eyes 86 is each attached to a respective one of the pair of lobes 18 of the shell 16 to enhance the ornamental appearance of the bin 12 with respect to the fish. Each of the pair of eyes 86 is spaced from the front end 28 of the shell 16 and each of the pair of eyes 86 is located on an apex of the respective lobe 18 of the shell 16.

A rake 88 is provided which has a plurality of tines 90 each comprised of a resiliently bendable material, including but not being limited to rubber or plastic, thereby enabling the rake 88 to rake toys and other children's objects 92 from the play area 36 and into the bin 12 for collection without damaging the toys and other children's objects 92. The rake 88 has a plurality of wings 94 each oriented to extend laterally away from the rake 88 to enhance the ornamental appearance of the rake 88. The rake 88 includes a body 96 which has a front surface 98 and a back surface 100; the back surface 100 is planar and the front surface 98 curves forwardly from the back surface 100.

The front surface 98 has a lower portion 102 and an upper portion 104; the lower portion 102 of the front surface 98 is rounded and the upper portion 104 of the front surface 98 has a lower end 108 which intersects the lower portion 102 of the front surface 98. The lower portion 102 has a radius which is greater than a radius of the lower end 108. The upper portion 104 curves outwardly from the lower end 108 and curves inwardly toward an upper end 110 of the upper portion 104 such that the upper portion 104 has a tear drop shape. The rake 88 includes a pair of arms 112 and each of the pair of arms 112 has a coupled end 114 which is coupled to the front surface 98 of the body 96 corresponding to the lower portion 102. Each of the pair of arms 112 extends laterally away from the lower portion 102 in opposite directions from each other. Additionally, each of the pair of arms 112 has a forward surface 116 which curves forwardly from a rear surface 118 and the rear surface 118 of each of the pair of arms 112 is planar.

Each of the plurality of tines 90 has an upper end 120 of the plurality of tines 90 and a lower end 122 of the plurality of tines 90. Each of the plurality of tines 90 has a first bend 123 which is spaced from the upper end 120 of a respective tine 90 and a second bend 124 that is spaced from the lower end 122 of the respective tine 90 thereby defining an upper section 125 of the plurality of tines 90 and a middle section 126 of the plurality of tines 90 and a lower section 127 of the plurality of tines 90. The upper section 125 of each of the tines 90 is associated with the upper end 120 of a respective tine 90 and the lower section 127 of each of the plurality of tines 90 is associated with the lower end 122 of a respective tine 90.

The plurality of tines 90 includes a first set of tines 128 and the upper end 120 of each of the first set of tines 128 is coupled to the front surface 98 of the lower portion 102 of the body 96 of the rake 88 having each of the first set of tines 128 extending downwardly from the lower portion 102 of the body 96. The plurality of tines 90 includes a second set of tines 130 and the upper end 120 of each of the second set of tines 130 is coupled to the forward surface 116 of a respective one of the pair of arms 112. Additionally, each of the second set of tines 130 extends downwardly from an intersection between the forward surface 116 of the respective arm 112 and the rear surface 118 of the respective arm 112.

The plurality of wings 94 includes a plurality of first wings 132 and each of the plurality of first wings 132 has back edge 134 which is coupled to the upper portion 104 of the front surface 98 of the body 96 of the rake 88. Each of the plurality of first wings 132 has a top edge 137 which is perpendicular to the back edge 134 and a lower edge 138 curving between the top edge 137 and the back edge 134. The plurality of first wings 132 are spaced apart from each other and are distributed around the upper portion 104 of the front surface 98 of the body 96. The plurality of wings 94 includes a second wing 139 which has an upper edge 140 and a bottom edge 141 curving downwardly from the upper edge 140. The bottom edge 141 is coupled to the upper end 110 of the upper portion 104 of the front surface 98 of the body 96 of the rake 88 at a point which is centrally located along the bottom edge 141.

A rake handle 142 is attached to and extends upwardly from the a respective one of the plurality of wings 94 thereby enabling the rake handle 142 to be gripped by the user 40 for raking the toys and other children's objects 92 into the bin 12 for collection. The rake handle 142 has a telescopically adjustable height to accommodate the user's 40 preference for gripping the rake handle 142. The rake handle 142 comprises a bottom section 144 which slidably receives a top section 146 thereby enabling the rake handle 142 to have the telescopically adjustable height. The bottom section 144 has a lower end 148 of the bottom section 144 which is coupled to the upper edge 140 of the second wing 139 at a point which is centrally located along the upper edge 140 of the second wing 139. The bottom section 144 has an upper end 150 of the bottom section 144 which is open for insertably receiving the top section 146 of the rake handle 142 and an outer surface 152 of the bottom section 144 has threads 154 located adjacent to the upper end 150 of the bottom section 144.

An annular collar 156 is provided which has an interior surface 158 and the interior surface 158 has threads 160 which are located adjacent to a bottom end 162 of the annular collar 156. The annular collar 156 extends around the bottom section 144 of rake handle 142 having the threads 160 on the interior surface 158 threadably engaging the threads 154 on the outer surface 152 of the bottom section 144 of the rake handle 142. The interior surface 158 has an angled portion 164 which angles inwardly between the threads 160 on the interior surface 158 and a top end 166 of the annular collar 156. Additionally, the angled portion 164 of the interior surface 158 compresses the upper end 150 of the bottom section 144 of the rake handle 142 against the bottom section 144 of the rake handle 142 when the annular collar 156 is tightened on the bottom section 144 of the rake handle 142. In this way the annular collar 156 can retain the rake handle 142 at a desired telescopic length.

A grip 168 is attached to the top section 146 of the rake handle 142 thereby enabling the grip 168 to be gripped. The grip 168 extends downwardly from a top end 170 of the top section 146 of the rake handle 142. Additionally, the grip 168 has an aperture 172 extending laterally through the grip 168 to enable the rake handle 142 to be suspended from a support for storing the rake 88. The grip 168 is comprised of a resiliently compressible material, including but not being limited to rubber or silicone, to enhance comfort for the user 40.

In use, the bin handle 38 is gripped to position the bin 12 in a desired location and the rake handle 142 is gripped to enable to the rake 88 to rake the toys and other children's objects 92 into the bin 12 for collection. In this way the toys and other children's objects 92 can be quickly and easily collected from the play area 36 and transported in the bin 12 to a storage space, for example, or other location where the toys and other children's objects 92 are intended to be kept while not being used. Thus, the user 40 does not have to bend over and manually collect the toys and other children's objects 92 from the play area 36 and carry the toys and other children's objects 92 to the storage space. Additionally, the bin 12 is generously sized to enable the bin 12 to contain a large number of toys and other children's objects 92 thereby facilitating the toys and other children's objects 92 to be quickly gathered and put away.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A rake and bin device for collecting toys and other children's objects from a play area, said device comprising:
a bin having a lower wall and a shell extending upwardly from said lower wall to define a collection space in said bin, said shell being structured to have a pair of lobes each being spaced upwardly from said lower wall and being elongated to extend along a full length of said lower wall having said pair of lobes being laterally spaced apart from each other wherein said bin is configured to have the ornamental appearance of a fish with an open mouth;
a bin handle being attached to and extending upwardly from said shell wherein said bin handle is configured to be gripped by a user for positioning said bin;
a pair of fins, each of said pair of fins being coupled to and extending laterally away from opposite sides of said shell wherein each of said pair of fins is configured to enhance the ornamental appearance of said bin with respect to the fish;
a tail being coupled to and extending rearwardly from said shell wherein said tail is configured to enhance to the ornamental appearance of said bin with respect to the fish;
a pair of eyes, each of said pair of eyes being attached to a respective one of said pair of lobes of said shell wherein each of said pair of eyes is configured to enhance the ornamental appearance of said bin with respect to the fish;
a rake having a plurality of tines each being comprised of a resiliently bendable material wherein said rake is configured to rake toys and other children's objects from the play area and into said bin for collection without damaging the toys and other children's objects, said rake having a plurality of wings each being oriented to extend laterally away from said rake wherein said plurality of wings is configured to enhance the ornamental appearance of said rake; and
a rake handle being attached to and extending upwardly from said a respective one of said plurality of wings wherein said rake handle is configured to be gripped by the user for raking the toys and other children's objects into said bin for collection, said rake handle having a telescopically adjustable height wherein said rake handle is configured to accommodate the user's preference for gripping said rake handle.

2. The device according to claim 1, wherein:
said shell has a pair of lateral walls each extending upwardly from a respective one of a first lateral edge and a second lateral edge of said lower wall;
each of said pair of lateral walls intersects a respective one of said pair of lobes;
said shell has a medial section extending between said pair of lobes;
said medial section lies on a plane being oriented parallel to said lower wall;
said shell has a front end being open into said collection space;
said shell having a rear end being closed; and
a bottom surface of said lower wall lies on a plane being horizontally oriented wherein said bottom surface of said lower wall is configured to rest on a floor of a play area.

3. The device according to claim 2, wherein:
said bin handle has a bottom portion being attached to and extending upwardly from an exterior surface of said medial section of said shell at a point being spaced from said front end of said shell; and
said bin handle has a top portion being perpendicular to said bottom portion such that said top portion is spaced from and is oriented parallel with said exterior surface of said medial section wherein said top portion is configured to be gripped.

4. The device according to claim 2, wherein:
each of said pair of fins has a coupled edge being coupled to an exterior surface of a respective one of said pair of lateral walls of said shell; and
each of said pair of fins is positioned between said lower wall and a respective one of said pair of lobes of said shell.

5. The device according to claim 2, wherein:
each of said pair of fins has a perimeter edge being curved to define a front lobe of a respective fin and a rear lobe of said respective fin;
said front lobe of each of said pair of fins curves laterally away from said exterior surface of said respective lateral wall of said shell;
said rear lobe of each of said pair of fins curves toward said rear end of said shell; and
each of said pair of fins is oriented to lie on a plane being oriented parallel to said lower wall of said bin.

6. The device according to claim 1, wherein:
said device includes a plurality of first disks; and
each of said plurality of first disks has a coupled surface being attached to an exterior surface of a respective one of said pair of lobes of said shell wherein each of said plurality of first disks is configured to have the ornamental appearance of scales of the fish;
said plurality of first disks includes a first row of first disks being evenly spaced apart from each other and being distributed along an axis extending between said front end and said rear end of said shell;
said plurality of first disks includes a second row of first disks being evenly spaced apart from each other and being distributed along said axis extending between said front end and said rear end of said shell;
said second row of first disks is positioned beneath said first row of first disks; and
each of said second row of said first disks is staggered with respect to each of said first row of said first disks.

7. The device according to claim 1, wherein:
said device includes a plurality of first disks;
said device includes a plurality of second disks; and
each of said plurality of second disks has a coupled surface being attached to an exterior surface of a respective one of said pair of lobes of said shell wherein each of said plurality of second disks is configured to have the ornamental appearance of scales of the fish;
said plurality of second disks includes a first row of second disks being evenly spaced apart from each other and being distributed along said axis extending between said front end and said rear end of said shell;
said plurality of second disks includes a second row of second disks being evenly spaced apart from each other and being distributed along said axis extending between said front end and said rear end of said shell;
said second row of second disks is positioned beneath said first row of second disks; and
each of said second row of said second disks being staggered with respect to each of said first row of said second disks.

8. The device according to claim 3, wherein:
said device includes a plurality of third disks;
each of said plurality of third disks has a coupled surface being attached to said exterior surface of said medial section of said shell wherein each of said plurality of third disks is configured to have the ornamental appearance of scales of the fish; and
said plurality of third disks is evenly spaced apart from each other and is distributed between said front end of said shell and said lower portion of said bin handle.

9. The device according to claim 1, wherein:
said rake includes a body having a front surface and a back surface;
said back surface is planar;
said front surface curves forwardly from said back surface;
said front surface has a lower portion and an upper portion;
said lower portion is rounded;
said upper portion has a lower end which intersects said lower portion;
said lower portion has a radius being greater than a radius of said lower end; and
said upper portion curves outwardly from said lower end and curves inwardly toward an upper end of said upper portion such that said upper portion has a tear drop shape.

10. The device according to claim 9, wherein:
said rake includes a pair of arms;
each of said pair of arms has a coupled end being coupled to said front surface of said body corresponding to said lower portion;
each of said pair of arms extends laterally away from said lower portion in opposite directions from each other;
each of said pair of arms has a forward surface curving forwardly from a rear surface; and
said rear surface of each of said pair of arms is planar.

11. The device according to claim 1, wherein:
each of said plurality of tines has an upper end of said plurality of tines and a lower end of said plurality of tines;
each of said plurality of tines has a first bend being spaced from said upper end of a respective tine and a second bend being spaced from said lower end of said respective tine thereby defining an upper section of said plurality of tines and a middle section of said plurality of tines and a lower section of said plurality of tines;
said upper section of each of said tines is associated with said upper end of a respective tine; and
said lower section of each of said plurality of tines is associated with said lower end of a respective tine.

12. The device according to claim 11, wherein:
said plurality of tines including a first set of tines;
said upper end of each of said first set of tines is coupled to said front surface of said lower portion of said body of said rake having each of said first set of tines extending downwardly from said lower portion of said body;
said plurality of tines includes a second set of tines; and
said upper end of each of said second set of tines is coupled to said forward surface of a respective one of said pair of arms having each of said second set of tines extending downwardly from an intersection between said forward surface of said respective arm and said rear surface of said respective arm.

13. The device according to claim 9, wherein:
said plurality of wings includes a plurality of first wings;
each of said plurality of first wings has back edge being coupled to said upper portion of said front surface of said body of said rake;
each of said plurality of first wings has a top edge being perpendicular to said back edge and a lower edge curving between said top edge and said back edge; and
said plurality of first wings being spaced apart from each other and being distributed around said upper portion of said front surface of said body.

14. The device according to claim 2, wherein:
said plurality of wings includes a plurality of first wings;
said plurality of wings includes a second wing having an upper edge and a bottom edge curving downwardly from said upper edge; and
said bottom edge is coupled to said upper end of said upper portion of said front surface of said body of said rake at a point being centrally located along said bottom edge.

15. The device according to claim 14, wherein:
said rake handle comprises a bottom section which slidably receives a top section thereby enabling said rake handle to have said telescopically adjustable height; and
said bottom section has a lower end of said bottom section being coupled to said upper edge of said second wing at a point being centrally located along said upper edge of said second wing.

16. The device according to claim 15, wherein:
said bottom section having an upper end of said bottom section being open for insertably receiving said top section of said rake handle; and
an outer surface of said bottom section having threads being located adjacent to said upper end of said bottom section.

17. The device according to claim 16, wherein:
said device includes an annular collar having an interior surface;
said interior surface has threads being located adjacent to a bottom end of said annular collar; and
said annular collar extends around said bottom section of rake handle having said threads on said interior surface threadably engaging said threads on said outer surface of said bottom section of said rake handle.

18. The device according to claim 17, wherein:
said interior surface has an angled portion which angles inwardly between said threads on said interior surface and a top end of said annular collar; and
said angled portion of said interior surface compresses said upper end of said bottom section of said rake handle against said bottom section of said rake handle when said annular collar is tightened on said bottom section of said rake handle for retaining said rake handle at a desired telescopic length.

19. A rake and bin device for collecting toys and other children's objects from a play area, said device comprising:
a bin having a lower wall and a shell extending upwardly from said lower wall to define a collection space in said bin, said shell being structured to have a pair of lobes each being spaced upwardly from said lower wall and being elongated to extend along a full length of said lower wall having said pair of lobes being laterally spaced apart from each other wherein said bin is configured to have the ornamental appearance of a fish with an open mouth, said shell having a pair of lateral walls each extending upwardly from a respective one of a first lateral edge and a second lateral edge of said lower wall, each of said pair of lateral walls intersecting a respective one of said pair of lobes, said shell having a medial section extending between said pair of lobes, said medial section lying on a plane being oriented parallel to said lower wall, said shell having a front end being open into said collection space, said shell having a rear end being closed, a bottom surface of said lower wall lying on a plane being horizontally oriented wherein said bottom surface of said lower wall is configured to rest on a floor of a play area;
a bin handle being attached to and extending upwardly from said shell wherein said bin handle is configured to be gripped by a user for positioning said bin, said bin handle having a bottom portion being attached to and extending upwardly from an exterior surface of said medial section of said shell at a point being spaced from said front end of said shell, said bin handle having an top portion being perpendicular to said bottom portion such that said top portion is spaced from and is oriented parallel with said exterior surface of said medial section wherein said top portion is configured to be gripped;
a pair of fins, each of said pair of fins being coupled to and extending laterally away from opposite sides of said shell wherein each of said pair of fins is configured to enhance the ornamental appearance of said bin with respect to the fish, each of said pair of fins having a coupled edge being coupled to an exterior surface of a respective one of said pair of lateral walls of said shell, each of said pair of fins being positioned between said lower wall and a respective one of said pair of lobes of said shell, each of said pair of fins having a perimeter edge being curved to define a front lobe of a respective fin and a rear lobe of said respective fin, said front lobe of each of said pair of fins curving laterally away from said exterior surface of said respective lateral wall of said shell, said rear lobe of each of said pair of fins curving toward said rear end of said shell, each of said pair of fins being oriented to lie on a plane being oriented parallel to said lower wall of said bin;
a tail being coupled to and extending rearwardly from said shell wherein said tail is configured to enhance to the ornamental appearance of said bin with respect to the fish, said tail being positioned on said rear end of said shell, said tail having a perimeter edge of said tail being curved to define a lobe of said tail which extends rearwardly and upwardly from said rear end of said shell;
a plurality of first disks, each of said plurality of first disks having a coupled surface being attached to an exterior surface of a respective one of said pair of lobes of said shell wherein each of said plurality of first disks is configured to have the ornamental appearance of scales of the fish, said plurality of first disks including a first row of first disks being evenly spaced apart from each other and being distributed along an axis extending between said front end and said rear end of said shell, said plurality of first disks including a second row of first disks being evenly spaced apart from each other and being distributed along said axis extending between said front end and said rear end of said shell, said second row of first disks being positioned beneath said first row of first disks, each of said second row of said first disks being staggered with respect to each of said first row of said first disks;
a plurality of second disks, each of said plurality of second disks having a coupled surface being attached to said exterior surface of a respective one of said pair of lobes of said shell wherein each of said plurality of second disks is configured to have the ornamental appearance of scales of the fish, said plurality of second disks including a first row of second disks being evenly spaced apart from each other and being distributed along said axis extending between said front end and said rear end of said shell, said plurality of second disks including a second row of second disks being evenly spaced apart from each other and being distributed along said axis extending between said front end and said rear end of said shell, said second row of second disks being positioned beneath said first row of second disks, each of said second row of said second disks being staggered with respect to each of said first row of said second disks;
a plurality of third disks, each of said plurality of third disks having a coupled surface being attached to said exterior surface of said medial section of said shell wherein each of said plurality of third disks is configured to have the ornamental appearance of scales of the fish, said plurality of third disks being evenly spaced apart from each other and being distributed between said front end of said shell and said bottom portion of said bin handle;
a pair of eyes, each of said pair of eyes being attached to a respective one of said pair of lobes of said shell wherein each of said pair of eyes is configured to enhance the ornamental appearance of said bin with respect to the fish, each of said pair of eyes being spaced from said front end of said shell, each of said pair of eyes being located on an apex of said respective lobe of said shell;
a rake having a plurality of tines each being comprised of a resiliently bendable material wherein said rake is configured to rake toys and other children's objects from the play area and into said bin for collection without damaging the toys and other children's objects, said rake having a plurality of wings each being oriented to extend laterally away from said rake wherein said plurality of wings is configured to enhance the ornamental appearance of said rake, said rake including a body having a front surface and a back surface, said back surface being planar, said front surface curving forwardly from said back surface, said front surface having a lower portion and an upper portion, said lower portion being rounded, said upper portion having a lower end which intersects said lower portion, said lower portion having a radius being greater than a radius of said lower end, said upper portion curving outwardly from said lower end and curving inwardly toward an upper end of said upper portion such that said upper portion has a tear drop shape, said rake including a pair of arms, each of said pair of arms having a coupled end being coupled to said front surface of said body corresponding to said lower portion, each of said pair of arms extending laterally away from said lower portion in opposite directions from each other, each of said pair of arms having a forward surface curving forwardly from a rear surface, said rear surface of each of said pair of arms being planar;
wherein each of said plurality of tines has an upper end of said plurality of tines and a lower end of said plurality of tines, each of said plurality of tines having a first bend being spaced from said upper end of a respective tine and a second bend being spaced from said lower end of said respective tine thereby defining an upper section of said plurality of tines and a middle section of said plurality of tines and a lower section of said plurality of tines, said upper section of each of said tines being associated with said upper end of a respective tine, said lower section of each of said plurality of tines being associated with said lower end of a respective tine, said plurality of tines including a first set of tines, said upper end of each of said first set of tines being coupled to said front surface of said lower portion of said body of said rake having each of said first set of tines extending downwardly from said lower portion of said body, said plurality of tines including a second set of tines, said upper end of each of said second set of tines being coupled to said forward surface of a respective one of said pair of arms having each of said second set of tines extending downwardly from an intersection between said forward surface of said respective arm and said rear surface of said respective arm;
wherein said plurality of wings includes a plurality of first wings, each of said plurality of first wings having back edge being coupled to said upper portion of said front surface of said body of said rake, each of said plurality of first wings having a top edge being perpendicular to said back edge and a lower edge curving between said top edge and said back edge, said plurality of first wings being spaced apart from each other and being distributed around said upper portion of said front surface of said body;
wherein said plurality of wings includes a second wing having an upper edge and a bottom edge curving downwardly from said upper edge, said bottom edge being coupled to said upper end of said upper portion of said front surface of said body of said rake at a point being centrally located along said bottom edge;
a rake handle being attached to and extending upwardly from said a respective one of said plurality of wings wherein said rake handle is configured to be gripped by the user for raking the toys and other children's objects into said bin for collection, said rake handle having a telescopically adjustable height wherein said rake handle is configured to accommodate the user's preference for gripping said rake handle, said rake handle comprising a bottom section which slidably receives a top section thereby enabling said rake handle to have said telescopically adjustable height, said bottom section having a lower end of said bottom section being coupled to said upper edge of said second wing at a point being centrally located along said upper edge of said second wing, said bottom section having an upper end of said bottom section being open for insertably receiving said top section of said rake handle, an outer surface of said bottom section having threads being located adjacent to said upper end of said bottom section;
an annular collar having an interior surface, said interior surface having threads being located adjacent to a bottom end of said annular collar, said annular collar extending around said bottom section of rake handle having said threads on said interior surface threadably engaging said threads on said outer surface of said bottom section of said rake handle, said interior surface having an angled portion which angles inwardly between said threads on said interior surface and a top end of said annular collar, said angled portion of said interior surface compressing said upper end of said bottom section of said rake handle against said bottom section of said rake handle when said annular collar is tightened on said bottom section of said rake handle for retaining said rake handle at a desired telescopic length; and
a grip being attached to said top section of said rake handle thereby enabling said grip to be gripped, said grip extending downwardly from a top end of said top section of said rake handle, said grip having an aperture extending laterally through said grip wherein said aperture is configured to enable said rake handle to be suspended from a support for storing said rake.
